(19) United States
(12) Patent Application Publication
(10) Pub. No.: US 2024/0336720 A1
(43) Pub. Date: Oct. 10, 2024

(54) POLYURETHANE UREA FIBER OR FILM AND PREPARATION METHOD THEREOF

(71) Applicant: BASF SE, Ludwigshafen am Rhein (DE)

(72) Inventors: Xiu Juan Zhang, Shanghai (CN); Dieter Rodewald, Ludwigshafen (DE); Da Shi, Shanghai (CN); Ming Qian Zhou, Shanghai (CN); Dian Bo Jiang, Shanghai (CN)

(73) Assignee: BASF SE, Ludwigshafen am Rhein (DE)

(21) Appl. No.: 18/573,796

(22) PCT Filed: Jun. 22, 2022
(86) PCT No.: PCT/EP2022/067022

§ 371 Date: Dec. 22, 2023

(30) Foreign Application Priority Data
Jun. 28, 2021 (WO) PCT/CN2021/102756

(51) Int. Cl. C08G 18/42; C08G 18/10; C08G 18/32; C08G 18/76; D01D 1/02; D01F 6/78

(52) U.S. Cl. CPC C08G 18/4252; C08G 18/10; C08G 18/3228; C08G 18/7671; D01D 1/02; D01F 6/78; D10B 2331/10; D10B 2331/12

(57) ABSTRACT

A polyurethane urea fiber or film is made having high elongation, low modulus, low hysteresis loss, and excellent clastic recovery. The clastic polyurethane clastic fiber or film is formed from a copolymer glycol, a diisocyanate, a chain extender and optionally a chain terminator. The hard segment content of the polyurethane fibers is in the range of 8.0-13.0% by weight.

### TECHNICAL FIELD

The present invention relates to a polyurethane urea fiber or film and its preparation method. It further relates to a polyurethane urea fiber or film having high elongation, low modulus, excellent elastic recovery as well as low hysteresis loss.

### BACKGROUND

Elastic polyurethane urea fibers possess outstanding elasticity and substantial extensibility combined with high retractive forces. Owing to this outstanding combination of properties, they are widely used in innerwear, outerwear, sportswear, swimming-wear, socks, girdles, medical articles, hygienic products, etc. Such elastic polyurethane fibers and processes for producing them are described in U.S. Pat. Nos. 5,541,280, 6,692,828, EP1401946, DE19931255, JP 63-219620 and U.S. Pat. No. 6,503,996.

Disadvantages of these elastic polyurethane urea fibers include, in some applications, an insufficient breaking extension, which in turn permits incorporation in textiles only under comparatively low pretension; a still substantial increase in tension at the customary wearing extensions of 200 to 400%, which can lead to an unpleasant sense of pressure particularly at high contents of elastic polyurethane fiber, as for example sportswear, medical bandages, cuffs, socks or baby diapers.

A polyurethane urea fiber which shows extremely high breaking elongation or stretchability accompanying a low stretch stress usually can impart soft stretching, while poor recovery causes bulging or lagging after repeated big stretching or bending, like the case in leotards, sportwear, which deteriorates the comfortability and aesthetics of the related articles.

Balanced performance of polyurethane urea elastic fibers is demanded in soft-fit apparels in terms of a high elongation, low modulus, good elastic recovery as well as low hysteresis loss.

U.S. Pat. No. 5,000,899A discloses a process of using copolymer of tetrahydrofuran and 3-methyltetrahydrofuran to produce the polyurethane urea fibers with combined diamine mixtures, which shows good heat-setting properties, but improvement of elongation, elastic recovery and modulus are not mentioned.

U.S. Pat. No. 5,879,799A discloses a process of using copolymer of polyalkylene ether glycols composed of different alkylene ethers containing 2-10 carbon atoms to make polyurethane urea fiber with balanced performance among heat resistance, abrasion resistance, elongation and low temperature performance, while the modulus of the fibers thereof is high.

US20090182113A discloses a process of using a copolymer of polytetrahydrofuran glycol with isophthalic acid or isophthalic derivatives to produce the polyurethane urea fibers, however, the fibers produced thereof do not show the improvement of the bulging or lagging issue accompanied with the high stretch and low modulus; furthermore, because of lacking polymeric composition design, the polyurethane urea solutions produced shows poor polyurethane viscosity stability even in a polymer solid of 20% by weight and poor spinnability because of gelation and/or other side reactions would be expected.

Therefore, there is a demand to provide polyurethane urea fiber or film having high elongation, low modulus, excellent elastic recovery as well as low hysteresis loss.

### SUMMARY OF THE INVENTION

It is an object of the invention to provide a polyurethane urea fiber or film having balanced performance among high elongation, low modulus, excellent elastic recovery as well as low hysteresis loss.

It has been surprisingly found that the above objects can be achieved by following embodiments:

1. A polyurethane urea fiber or film comprises a hard segment content (HS) of 8.0-13.0% by weight, wherein said hard segment content is defined as equation below:

$$\\ Hard segment content ( HS ) = \frac{Mn ( urea )}{Mn ( urethane ) + Mn ( urea )} * 100 \%$$

wherein said polyurethane urea fiber or film is prepared via using copolymer glycol.

2. The polyurethane urea fiber or film according to item 1, wherein hard segment content thereof is in the range of 8.0-12.5% by weight, the urethane moieties have a number average molecular weight Mn (urethane) of 5000-9000 g/mol and the urea moieties have a number average molecular weight Mn (urea) of 500-900 g/mol; preferably hard segment content thereof is in the range of 8.5-12.5% by weight, the urethane moieties have a Mn (urethane) of 5500-8500 g/mol and the urea moieties have a Mn (urea) of 550-850 g/mol.

3. The polyurethane urea fiber or film according to item 1 or 2, wherein said copolymer glycol is prepared from at least one aromatic carboxylic acid and/or their anhydride and/or their ester with at least one polymeric glycol.

4. The polyurethane urea fiber or film according to any of items 1 to 3, wherein number average molecular weight (Mn) of said copolymer glycol is 500 to 5000 g/mol, preferably 1800 to 4000 g/mol, more preferably 2000-3500 g/mol.

5. The polyurethane urea fiber or film according to item 3 or 4, wherein the aromatic carboxylic acid and/or their anhydride and/or their ester moieties content in the copolymer glycol is 6.0-20.0% by weight.

6. The polyurethane urea fiber or film according to any of items 3 to 5, wherein the aromatic carboxylic acid and/or their anhydride and/or their ester is selected from isophthalic acid, dimethyl isophthalate, phthalic acid, terephthalic acid and their anhydrides; preferably selected from isophthalic acid, dimethyl isophthalate and mixture thereof, more preferably isophthalic acid.

7. The polyurethane urea fiber or film according to any of items 1 to 6, wherein the polymeric glycol is selected from the group of polytetrahydrofuran glycol, polyesterol, polyetherol, polycaprolactone and/or the mixture thereof; preferably the polymeric glycol comprises polytetrahydrofuran glycol; more preferably the polymeric glycol is polytetrahydrofuran glycol.

8. A process for producing the polyurethane urea fiber according to any of items 1 to 7, which comprises:
a) reacting copolymer glycol with at least one diisocyanate to obtain urethane prepolymer including isocyanate at both ends,
b) adding chain extender and optionally chain terminator to above urethane prepolymer under inert solvent to obtain polyurethane solution, and
c) dry spinning said polyurethane solution to obtain the polyurethane urea fiber.

9. The process according to item 8, wherein said diisocyanate comprises 4,4′-methylene diphenyl diisocyanate, preferably comprises more than 60% 4,4′-methylene diphenyl diisocyanate, more preferably more than 80% of 4,4′-methylene diphenyl diisocyanate, most preferably more than 95% of 4,4′-methylene diphenyl diisocyanate.

10. The process according to item 8 or 9, wherein the chain extender comprises aliphatic diamine having two hydrogen atoms reactive with isocyanate group; preferably said aliphatic diamine is selected from 1,2-ethylenediamine, 1,2-propylenediamine, 1,3-propylenediamine, 1,4-butanediamine, 1,5-pentane diamine, 1,4-cyclohexanediamine and mixture thereof; more preferably said aliphatic diamine is 1,2-ethylenediamine.

11. The process according to any of items 8 to 10, wherein the chain terminator is alkyl alcohol and/or dialkyl amine; preferably said chain terminator are selected from n-butanol, cyclo-hexanol, ethanolamine, diethanol amine, N, N-diethylamine, N, N-dibutylamine or mixtures thereof.

12. The process according to any of items 8 to 11, the amines other than chain extender and chain terminator are added together with the chain extender; preferably such amines other than chain extender and chain terminator are diethylene-triamine and/or diethanolamine.

13. The use of the polyurethane urea fiber according to any of items 1 to 7 for producing fabrics.

### DESCRIPTION OF THE DRAWING

FIG. 1 shows the HNMR spectrum of chemical shift of the methylene group within 4,4′-methylene diphenyl diisocyanate (4,4′-MDI) moieties in Example 2.

### DETAILED DESCRIPTION OF THE INVENTION

Unless defined otherwise, all technical and scientific terms used herein have the meaning commonly understood by a person skilled in the art to which the invention belongs. As used herein, the following terms have the meanings ascribed to them below, unless specified otherwise.

The undefined article “a”, “an” and “the” mean one or more of the species designated by the term following said article.

In the context of the present disclosure, any specific values mentioned for a feature (comprising the specific values mentioned in a range as the end point) can be recombined to form a new range.

It will be understood that the aforementioned and hereinbelow still to be elucidated features of the subject matter of the present invention are utilizable not only in the particular combination indicated, but also in other combinations without leaving the realm of the present invention.

In one embodiment, the polyurethane urea fiber of the present invention is prepared from copolymer glycol, at least one diisocyanate, at least one chain extender and optionally chain terminator.

The copolymer glycol in the present invention is substantially prepared by condensation of polymeric glycol with at least one aromatic carboxylic acid and/or their anhydride and/or their ester. In a preferred embodiment, said at least one aromatic carboxylic acid and/or their anhydride and/or their ester is isophthalic acid (IPA), phthalic acid, dimethyl isophthalate, terephthalic acid and their anhydrides, more preferably isophthalic acid and/or dimethyl isophthalate, most preferably isophthalic acid, in the presence of a transesterification catalyst, for example titanium tetrabutyl orthotitanate, tetraisopropyl orthotitanate, dibutyltin laurate, dibutyltin oxide, tin octoate, tin chloride, tin oxide, sulfuric acid, para-toluenesulfonic acid, potassium hydroxide, sodium methoxide, titanium zeolites, lipases or hydrolases immobilized on a carrier, preferably tetrabutyl orthotitanate (cross comparison) wherein in a multi-stage operation at different pressure levels with at least one reaction stage at atmospheric pressure and at least one reaction stage at reduced pressure, where distillate is removed from the reaction system, which process comprises heating the reaction mixture in two or more phases in the atmospheric-pressure reaction stage wherein the heating phases are interrupted by at least one phase in which the temperature is kept constant. The preparation process of copolymer glycol in the present invention is disclosed in US2012/0059143, especially paragraphs 0011 to 0028 and example 1 thereof, which is incorporated hereinafter as the reference.

Substantially means the main ingredients for the copolymer glycols are aromatic carboxylic acid and/or their anhydride and/or their ester with at least one polymeric glycol, other diacids can also be incorporated during the copolymerization, provided that such additional components don't seriously affect the performance of elastic fiber detrimentally.

Polymeric glycols used herein include but are not limited to polyesterols, and/or polyetherols, and/or polycaprolactone with two hydroxy group per molecule; for example, polyethers and copolyethers comprising polytetrahydrofuran glycol and derivatives thereof, such as polytetrahydrofuran glycol, poly (tetrahydrofuran-co-ethylene ether) glycol, polycarbonate glycols, such as poly (pentane-1,5-carbonate) glycol and poly (hexane-1,6-carbonate) glycol and poly (ethylene-co-propylene adipate) glycol and also polyesterols, such as polyesters of adipic acid, 1,4-butane diol and neopentyl glycol, of adipic acid, 1,4-butane diol and 1,6-hexane diol, of adipic acid and 1,4-butane diol, of adipic acid and 1,6-hexane diol, of dodecanedioic acid and neopentyl glycol, or of sebacic acid and neopentyl glycol. Preference is given to using polycaprolactone, polyesters of adipic acid and 1,4-butane diol, polytetrahydrofuran glycol, polyesters of adipic acid, butane diol and neopentyl glycol, polyesters of adipic acid, 1,4-butane diol and 1,6-hexane diol, polyesters of adipic acid and 1,6-hexane diol, polyesters of dodecanedioic acid and neopentyl glycol, or polyesters of sebacic acid and neopentyl glycol or mixtures thereof. Particular preference is given to using polytetrahydrofuran glycol alone or in mixtures with further glycols, in particular alone.

When polytetrahydrofuran glycol is used alone as polymeric glycol, the number average molecular weight Mn thereof is preferably from 200 to 2500 g/mol, more preferably from 200 to 2100 g/mol, most preferably from 500 to 1500 g/mol. Polytetrahydrofuran glycol with Mn less than 200 g/mol leads to inferior hysteresis loss of the resulting polyurethane urea fiber or film, polytetrahydrofuran glycol with number molecular weight higher than 1500 g/mol shows unsatisfactory high modulus.

In one embodiment, the aromatic carboxylic acid and/or its anhydride and/or its ester moieties is in the range of 6-20% by weight, depending on the starting molecular weight of polymeric glycol and targeted Mn of the copolymer glycol. The aromatic carboxylic acid and/or its anhydride and/or its ester moiety within the copolymer glycol is defined hereinbelow as the modifier. The modifier moiety fraction molecular weight is defined as the residue part of the diacid with 1mole H₂O subtracted in case diacid example isophthalic acid is used to make the copolymer, when diester for example dimethyl phthalate is used to make the copolymer, 1 mole dimethyl ether is subtracted, the modifier moiety fraction molecular weight in both cases is 148 g/mol.

In another embodiment, the number average molecular weight of the copolymer glycol Mn is from 500 to 5000 g/mol, preferably from 1800 to 4000 g/mol, and more preferably from 2000 to 3500 g/mol.

The diisocyanates suitable for the present invention include but are not limited to, aromatic diisocyanates, such as 4,4′-methylene diphenyl diisocyanate (4,4′-MDI), naphthylene diisocyanate (NDI), 2,4- or 2,6-tolulene diisocyanate (TDI), 1,4-phenyl diisocyanate, and aliphatic diisocyanates, such as 4,4′-diisocyanato-dicyclohexylmethane (HMDI), isophorone diisocyanate. They may be used individually or in combination. Aromatic diisocyanates are preferred, especially 4,4′-MDI. 2,4′-methylene diphenyl diisocyanates (2,4′-MDI) can be used combined with 4,4′-MDI by the molar percent of 2,4′-MDI less than 40%, preferably less than 20%, more preferably less than 5% of the total diisocyanates.

Chain extenders suitable for the present invention include compounds having two isocyanate-reactive hydrogen atoms and a molecular weight of less than 500 g/mol. Such substances are described for example in “Kunststoffhandbuch, 7, Polyurethane”, Carl Hanser Verlag, 3rd edition 1993, Chapter 3.4.3., such as ethylenediamine, 1,2-propylenediamine, 1,3-propylenediamine, 1,4-butanediamine, 1,5-diaminopentane, hydrazine, m-xylylenediamine, p-xylylenediamine, 1,4-cyclohexanediamine, 1,3-cyclohexanediamine, 1,3-diamine-4-methylcyclohexane, 1-amino-3-aminoethyl-3,3,5-trimethyl cyclohexane (isophoronediamine), 1,1′-methylenebis (4,4′-diamino-hexane) toluene diamine, piperazine, ethylene glycol, 1,2-propanediol, 1,3-propanediol, 1,4-butanediol, 1,5-pentanediol, 1,6-hexanediol or mixtures thereof. Particular preference is given to diamines, such as ethylenediamine, 1,2-propylenediamine, 1,3-propylenediamine, 1,4-butanediamine, 1,5-diaminopentane, hydrazine, m-xylylenediamine, p-xylylenediamine, 1,4-cyclohexanediamine, 1,3-cyclohexane-diamine, 4-methylcyclohexane-1,3-diamine, and isophoronediamine, diamino hexane and toluene diamine and also mixtures thereof, in particular ethylenediamine used solely or used together with above mentioned diamines by a mole ratio of 80% or more.

Optionally, chain terminator could also to be used in the preparation of the polyurethane urea fiber or film of the present invention. The chain terminator suitable for the present invention includes secondary amines, such as diethylamine, dibutylamine, dicyclohexylamine; or primary amines, such as ethanolamine, or primary alcohols, such as n-butanol, alone or as mixtures. Preferably the chain terminator is a monofunctional amine. It is possible to use specific amines, examples being diethylene-triamine or diethanolamine.

The preparation of the polyurethane urea polymer in the present invention can be done by the process as below.

First, the copolymer glycol is capped with diisocyanates in the mole ratio of diisocyanates to polymeric glycol in the range of 1.2-3.0, preferably in the range of 1.5-2.3. To control the hard segment content, the diisocyanates can be charged to the reactor stepwise, i.e. separate charging of diisocyanates to the reactors can lengthen both the soft segment moieties and hard segment moieties, which favors the stretchability and recovery of the polyurethane polymers.

When all the polymeric glycol OH groups turn into urethane groups, indicated by the residue NCO content by weight reaching the theoretical NCO % content, a urethane prepolymer is obtained which can be chain-extended with diamines in solvents, such as N, N-dimethyl acetamide (DMAC), N,N-dimethylformamide (DMF), etc. The theoretical NCO % content by weight upon the completion of the prepolymerization is calculated in the present invention as below:

$$\\ \begin{matrix}NCO \% ( theo ) = \frac{( R - 1 ) * 42.02 * 2}{Mdi * R + Mn ( copolymer )} * 100 & ( 1 )\end{matrix}$$

wherein, R is the molar ratio of the copolymer glycol or polymeric glycol to the diisocyanate, Mdi is the molecular weight of the diisocyanate, for example, in the present invention, when 4.4′-MDI is used, Mdi=250.26 g/mol.

Mn (copolymer) the number average molecular weight of the copolymer glycol or other polymeric glycol used in the preparation of the present polyurethane urea polymer, which is test by the method of ASTM 1899-2016.

Chain terminators like diethyl amine or n-butanol can be employed to control the polyurethane urea polymer molecular weight within processing range by the well-known process in this area.

During the prepolymerization process of copolymer glycol with diisocyanates, the NCO % to be reacted with amines after the complete conversion of OH-group of copolymer glycol to urethane group needs to be monitored to control the effective hard segment moieties content in the range of 8.0-13.0% by weight, preferably 8.0-12.5% by weight, more preferably 8.5-12.5% by weight. Otherwise, further reduction of NCO % content during and/or after the prepolymerization of copolymer glycol with diisocyanates will cause undesired gelation and/or drop of effective hard segment moieties content and deteriorate spinnability and/or the fiber stress-strain performance and recovery.

The NCO % to be capped by amines is the titrated NCO % content tested by method ASTM D2572-19 after the completion of the prepolymerization of diisocyanate with the copolymer glycol or polymeric glycols and before chain extension wherein NCO capped prepolymer reacts with amines. It is well known that the side reactions during prepolymerization of polymeric glycol with isocyanate and/or the side reaction during dissolving the prepolymer into the solvent like DMAC or DMF both will deteriorate the spandex spinning and elasticity performance.

The hard segment content in the present invention is defined as below:

$$\\ \begin{matrix}Hard segment content ( HS ) = \frac{Mn ( urea )}{Mn ( urethane ) + Mn ( urea )} * 100 \% & ( 2 )\end{matrix}$$

wherein Mn (urea) means the number average molecular weight of the urea moieties, and Mn (urethane) means the number average molecular weight of the of urethane moieties.

In the present invention, the hard segment content is tested by HNMR method. When the hard segment content is more than 13.0% by weight, the resulting polyurethane urea exhibits an unsatisfactory high modulus, e.g. higher than 10 MPa; additionally, gelation causes unstable processability. On the other hand, if the hard segment content is less than 8.0% by weight, the resulting polyurethane urea polymer shows unpleasant low recovery power and low elastic recovery rate, which further imparts bagging or lagging after repeated stretching or bending in clothes articles.

Given the hard segment content is in the range of 8.0-13.0% by weight, the Mdo, i.e. the Mn of the copolymer glycol is preferred in the range of 1800-4000 g/mol, more preferably in the range of 2000-3500 g/mol.

The fully reacted solution is subsequently spun to form a fiber. Any spinning process whereby a fiber in accordance with the present invention can be produced could be used. Such spinning processes are described for example in “Kunststoffhandbuch, 7, Polyurethane”, Carl Hanser Verlag, 3rd edition 1993, Chapter 13.2. These include dry-spinning or wet-spinning processes, preferably the dry-spinning process. In the spinning process, a spinning solution comprising the polyurethane urea of the present invention is spun through a spinneret die to form threads. The polyurethane urea fibers of the present invention are obtained after removing the spinning solvent, for example by drying.

The polyurethane urea fibers of the present invention may further comprise additives. Any additives known for polyurethane urea fibers can be used herein. For example, delusterants, fillers, antioxidants, dyes, pigments, dye enhancers, for example Methacrol 2462 B, and stabilizers against heat, light, UV radiation, chlorinated water and against the action of gas fumes and air pollution such as NO or NO₂ may be included. Examples of antioxidants, stabilizers against heat, light or UV radiation are stabilizers from the group of the sterically hindered phenols, for example Irganox®245 or Cyanox®1790, hindered amine light stabilizers, triazines, benzophenones and benzotriazoles. Examples of pigments and delusterants are titanium dioxide, magnesium stearate, zinc oxide and barium sulfate. Examples of stabilizers against fiber degradation by chlorine or chlorinated water are zinc oxide, magnesium oxide, or coated or uncoated magnesium aluminum hydroxycarbonates, for example hydrotalcites or huntites.

The polyurethane urea fibers of the present invention are useful for producing elastic textiles, for example wovens, knits, etc.

The following is the method for measuring the Mn of the urethane moieties, Mn of the urea moieties and the hard segment content of a polyurethane urea film in the present invention prepared with 4,4′-MDI as diisocyanate.

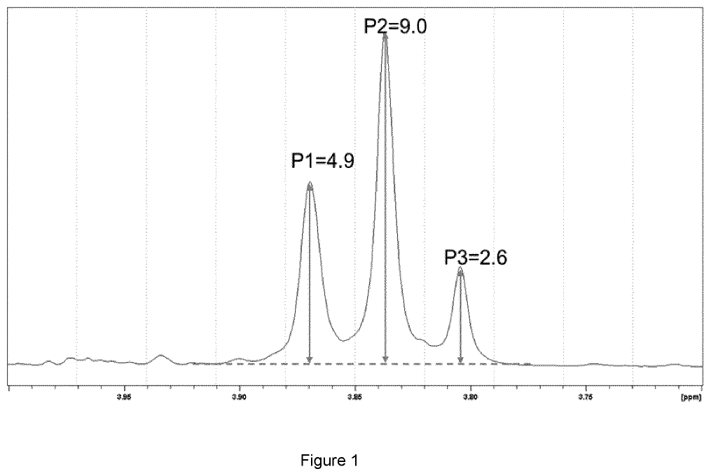

FIG. 1 illustrates an exemplary HNMR spectrum measured in the above conditions. In FIG. 1, the peak P1 with a height of 4.9 cm at 3.87 ppm representing the methylene group within the 4,4′-MDI moieties with both ends capped by urethane groups, the peak P2 with a height of 9.0 cm at 3.84 ppm representing the methylene group within the 4,4′-MDI moieties with one end capped by urethane groups and the other end capped by urea groups, the peak P3 with a height of 2.6 cm at 3.80 ppm representing the methylene group within the 4,4′-MDI moieties with both ends capped by urea groups. The peak heights as indicated by the numbers in cm in FIG. 1, are used as a measure for the moles of the moieties within the polyurethane polymer.

The soft segment Mn (urethane) in the present invention is calculated by:

$$\\ \begin{matrix}Mn ( urethane ) = 2 * P 1 / P 2 * ( Mdi + Mdo ) + Mdo & ( 3 )\end{matrix}$$

The hard segment Mn (urea) in the present invention is calculated by:

$$\\ \begin{matrix}Mn ( urea ) = 2 * P 3 / P 2 * ( Mda + Mdi ) + Mda + 2 Mdi & ( 4 )\end{matrix}$$

wherein Mdi is the molecular weight of diisocyanate, in the case of 4,4′-MDI, Mdi=250.26, Mda is the chain extender molecular weight, in the case mixed chain extenders are used, Mda is the averaged Mn of the mixed chain extender.

Mdo is the number average molecular weight of the copolymer glycol or other polymeric glycol used in the present invention. Mdo in the polyurethane urea polymer is tested by HNMR as below:

$$\\ \begin{matrix}Mdo = \frac{\frac{I ( 1.4 - 2. ppm )}{I ( 4. - 4.25 ppm )} * Mn ( poly\_r )}{( 1 - modifier moiety content )} + 18 & ( 5 )\end{matrix}$$

$$\\ \begin{matrix}Modifier moiety content = \frac{Mn ( modifer )}{\frac{I ( 1.4 - 2. ppm )}{I ( 8.2 - 8.4 ppm )} * Mn ( poly\_r ) * 0.44 + Mn ( modifer )} & ( 6 )\end{matrix}$$

wherein I (1.40-2.00 ppm) is the peak integration between chemical shift of 1.40 to 2.00 ppm, which is the characteristic chemical shift of polytetrahydrofuran glycol moieties within the polyurethane urea polymer, I (4.00-4.25 ppm) is the integration of —OCH2 attached to —NHCO—group within the polyurethane urea polymer, I (8.20-8.40 ppm) is the integration of the characteristic chemical shift of isophthalic moieties between 8.20 ppm to 8.40 ppm within the polyurethane urea polymer, Mn (modifer) is defined as the residue part of the diacid with 1mole H₂O subtracted in case diacid example isophthalic acid is used to make the copolymer, when diester for example dimethyl phthalate is used to make the copolymer, 1 mole dimethyl ether is subtracted, the modifier moiety fraction molecular weight in both cases is 148 g/mol, Mn (poly_r) is the molecular weight of repeating unit of polymeric glycol, when polytetrahydrofuran glycol is used alone, Mn (poly_r) is 72.

### EXAMPLES

In the present invention, the test methods of various properties are as following:

Method for determining the Mn of urethane moieties, urea moieties and hard segment content: the polyurethane urea fiber or film samples were cut into small pieces and dissolved in the deuterated dimethylformamide. The equipment and measuring conditions are summarized as below:

Measurement Instrument: Bruker AVANCE NEO 600 MHz with DCH Cryo probe Observed Nucleus: IH
Number of Accumulation: 128
Measurement Temperature: 25° C.
Measurement Concentration: 2.0% by weight
Chemical Shift Standard: Tetramethyl silane (0 ppm)

### Stress-Strain Performance Evaluations

For handling and reproducibility reasons, the mechanical properties of the polyurethane urea were measured on films. To this end, a solution of the polyurethane urea prepared was converted to a film by casting the solution onto a precisely horizontally aligned glass plate and allowing it to dry at 50° C. in a slow N₂ stream for 48 h. Amount and concentration of the solution as well as the plate area were matched to each other so as to produce a film about 0.20 to 0.26 mm in thickness. The films were mechanically tested in accordance with a) ISO037: 2005 (tensile test) and b) DIN 53835-2: 1981 (hysteresis loss).

The trends observed in films are essentially in line with those for the fibers, effects of polymer chain orientation seen in fibers and imparted by the spinning process are not reflected in film. Such differences do not impede the spirit of the present invention

The elastic properties of the specimen are tested by a 1KN Zwick/Roell Z2.5 with a KAF-TC force sensor of 1 kN.

Breaking elongation: take the standard shape and size film sample of polyurethane urea according to ISO37: 2005, change in length of the extended sample, expressed as % of the original length, at which the sample breaks. The breaking elongation of a polyurethane urea film in accordance with the present invention is greater than 500% and preferably greater than 600%, more preferably greater than 700%.

Modulus: take the standard shape and size film sample of polyurethane urea according to ISO37: 2005, test the stress of the sample under 300% elongation according to ISO37: 2005 with a unit of MPa. The lower modulus of the material, the softer and more comfortable of the articles converted herewith. In the present invention, the modulus of the film is preferred 13 MPa or lower, more preferred 10 MPa or lower.

Hysteresis loss: take the standard shape and size film sample of polyurethane according to ISO37: 2005, stretch the sample for 5 times according to DIN53835-2:1981.

The relative stress loss after repeated elongation b5= (the first 300% elongation stress—the fifth 300% elongation stress)/the first 300% elongation stress*100. The b5 of polyurethane urea film in the present invention is preferably 20 or less, more preferably 15 or less. The hysteresis loss coefficient H5=F150,5th unload/F150,5th load, H5 is the force ratio of the unload force and load force in the 5th cycle stretch-recovery at 150% strain. The H5 of polyurethane film in accordance with the present invention is preferably 0.70 or more.

Rate of elastic recovery RER %: take the standard shape and size film sample of polyurethane urea according to ISO37: 2005, stretch the sample for 5 times and then test the length of the sample thereafter according to DIN53835-2:1981, elastic recovery rate is calculated as below:

$$\\ RER \% = ( \begin{matrix}1 - ( the fifth recovery length of 300 \% elongation - initiate length ) / \\ ( 300 \% elongation length - initiate length )\end{matrix} ) * 100 \% .$$

% RER of polyurethane urea film in accordance with the present invention is preferably 90% or more.

The present invention will be specifically illustrated with reference examples, although the invention is not limited thereto. Further embodiments of the present invention are discernible from the claims, the descriptions, and the examples.

### Materials Used:

Lupranate® M: 4,4′-MDI from BASF
DMAC: N, N-dimethyl acetamide from BASF
EDA: 1,2-ethylenediamine from BASF
DEA: N, N-diethyl amine from BASF
Irganox®245: CAS36443-68-2 from BASF
Tinuvin®622: CAS 70198-29-7 from BASF
Deuterated DMF: CAS 4472-41-7 from Merk.
PolyTHF®: polytetrahydrofuran glycol from BASF

### Copolymer Glycol Preparation:

Copolymer 1 is the copolymer glycol prepared according to the procedure in Example 1 of US2012/0059143. 841parts PolyTHF® 650 (Mn 650 g/mol) were reacted with 166 parts of isophthalic acid under catalysis of 20 ppm by weight of tetrabutyl orthotitanate to PolyTHF® 650 by gradually increasing temperature to 220° C. and reducing pressure to 20 mbar. When the acid number reaches 1 mgKOH/g or less, the temperature was cooled to 200° C., 20 ppm of 85% by weight of phosphoric acid were charged, then further cooled down, the resulting copolymer glycol 1 has a OH number of 34 mgKOH/g. Copolymer 2 to 4 were prepared according to the same procedures as described above in Copolymer 1, the number average molecular weight of starting PolyTHF® and final copolymer glycol are summarized in table 1, both of which were tested according to ASTM-1899-2016.

TABLE 1

| | Mn of PolyTHF ® | Mn(copolymer) |
|---|---|---|
| | (g/mol) | (g/mol) |
| Copolymer-1 | 650 | 3300 |
| Copolymer-2 | 1000 | 3000 |
| Copolymer-3 | 650 | 3000 |
| Copolymer-4 | 650 | 2600 |

### Example 1

100.00 parts by weight Copolymer 1, 13.50 parts by weight 4,4′-MDI which is referred to as MDI-1 in table 2, were charged in to the N₂ purged reactor to form a NCO-capped prepolymer with a NCO content of 1.75%, then the NCO capped prepolymer was cooled to 40° C. and dissolved in 138.72 parts by weight DMAC (referred to as DMAC-1 in table 2). To this diluted prepolymer solution, a solution of 1.34 parts by weight EDA as chain extender, and 0.30 parts by weight DEA in 105.94 parts by weight DMAC (referred to as DMAC-2 in table 2) was charged by high speed mixing to get a homogeneous polyurethane solution.

Additive slurry of 0.5% Irganox®245, 0.2% Tinuvin®622, 0.2% magnesium stearate and 0.5% titanium dioxide based on the solid polyurethane polymer weight were charged into above polyurethane urea solution. The viscosity of the resultant dope solution is 2000 poise at 30° C. This dope solution was cast into a film with a thickness of 0.24 mm and 15 mg of this film (cut into small pieces) was dissolved in deuterated DMF and investigated via HNMR. The properties of the polyurethane urea film thus obtained were tested in according to the methods as described above and the measured results are summarized in table 3.

### Examples 2-6

The polyurethane urea films were prepared in the similar manner as in Example 1, except for using the respective raw materials and amounts thereof as illustrated in table 2. The properties of the polyurethane urea film thus obtained were tested according to the methods as described above and the measured results are summarized in table 3.

### Comparative 1

100.00 parts by weight Copolymer 2 was mixed with 14.48 parts by weight 4,4′-MDI which is referred to as MDI-1 in table 2, to get a NCO capped prepolymer with NCO content of 1.80% by weight, then the prepolymer was cooled and dissolved in 139.92 parts by weight DMAC-1, while during the dissolving process, the system was not sealed either mechanically or by inert gas, like N₂, the NCO % capped by amines depleted to 1.25% by weight because of side reactions, wherein the NCO capped by amines here indicates the NCO content left in the prepolymer just upon the charge of amine solution for chain extension. Then a solution of 0.97 parts by weight EDA as chain extender, 0.21 parts by weight DEA as chain terminator in 105.86 parts by weight DMAC-2 was charged with fast stirring to get a polyurethane urea solution. The same additives as in Example 1 were charged to get a polyurethane urea solution with a viscosity of 1400 poise at 30° C.

The thus got polyurethane urea film showed a hard segment HS of 6.5% in table 3.

The % RER dropped to 87%, bulging or lagging in converted fabrics happened based on spinning, further knitting and repeated wearing trials results.

### Comparative 2

100.00 parts by weight Copolymer 2 was reacted with 14.95 parts by weight 4,4′-MDI (referred to as MDI-1 in table 2), to get a NCO capped prepolymer with NCO content of 1.93% by weight, then additional 4.67 parts by weight 4,4′-MDI (referred to as MDI-2 in table 2) were charged into the cooled prepolymer and stirred to a homogeneous mixture. To this mixture, 146.20 parts by weight DMAC (referred to as DMAC-1 in table 2) were charged to get a prepolymer solution. Then a solution of 2.45 parts by weight EDA as chain extender, 0.54 parts by weight DEA as chain terminator in 114.34 parts by weight DMAC (referred to as DMAC-2 in table 2) were charged, followed by additive charging as in Example 1 to get a polyurethane urea solution with a viscosity of 2300 poise at 30° C.

The polyurethane urea solution viscosity increased to 8000 poise after standing at 50° C. for 72 hours, out of the spinnability range. In the present invention, the dope viscosity has to be controlled between 2000-6000 poise within 72 hours aging at 50° C., otherwise yarn breaking, twinning and curling are serious based on spinning trial results.

Beside the high and fast viscosity change during aging, the polyurethane urea film showed a modulus of 13.6 MPa as shown in table 3.

### Comparative 3 & 4

The polyurethane urea elastomers were prepared in similar manner as in Example 1, except for the respective raw materials and amounts thereof as illustrated in table 2, wherein in Comparative 3, PolyTHF® with Mn of 3000 instead of Copolymer 1 was used; in Comparative 4, PolyTHF® with Mn of 1850 instead of Copolymer 1 was used.

In Comparative 3 and Comparative 4, the polyurethane urea films show high recovery rates of 101% and 98% respectively, but the high modulus and high energy losses of b5 in table 3 can't meet the requirements for downstream applications where comfort and fit are required.

### Comparative 5

100.00 parts by weight Copolymer 2 were reacted with 15.20 parts by weight 4,4′-MDI which is referred to as MDI-1 in table 2, to get a NCO capped prepolymer with an NCO content of 1.60% by weight instead of 2.00% by weight because of excessive NCO depletion either by NCO side reactions or by impurities, such as water during the polymerization process, then the prepolymer was dissolved in 140.80 parts by weight DMAC-1, then a solution of 1.24 parts by weight EDA as chain extender, and 0.28 parts by weight DEA as chain terminator in 107.23 parts by weight DMAC-2 was charged with fast stirring, the polymer solution showed severe gelation, with the polyurethane urea dope clinging to the stirring blade, the viscosity was over 10,000 poise, far beyond the spinnability range of 2000-6000 poise, further measurements were not done anymore.

The polyurethane urea films prepared according to the present invention show balanced high elongation, low modulus, low hysteresis loss and good recovery.

TABLE 2

| | | | | Copolymer | NCO % | NCO % capped | | | | |
|---|---|---|---|---|---|---|---|---|---|---|
| | | MDI-1/g | MDI-2/g | of PTHF/g | (Theo) | by amines | EDA/g | DEA/g | DMAC-1 | DMAC-2 |
| Example 1 | Copolymer-1 | 13.50 | 0.00 | 100.00 | 1.75% | 1.75% | 1.34 | 0.30 | 138.72 | 105.94 |
| Example 2 | Copolymer-2 | 14.66 | 0.00 | 100.00 | 1.85% | 1.85% | 1.43 | 0.32 | 140.14 | 107.23 |
| Example 3 | Copolymer-2 | 15.20 | 0.00 | 100.00 | 2.00% | 2.00% | 1.56 | 0.34 | 140.80 | 108.04 |
| Example 4 | Copolymer-2 | 16.31 | 0.00 | 100.00 | 2.30% | 2.30% | 1.81 | 0.40 | 142.15 | 109.69 |
| Example 5 | Copolymer-3 | 14.15 | 0.00 | 100.00 | 1.71% | 1.71% | 1.32 | 0.29 | 139.52 | 106.48 |
| Example 6 | Copolymer-4 | 16.02 | 0.00 | 100.00 | 1.85% | 1.85% | 1.45 | 0.32 | 141.80 | 108.50 |
| Comparative 1 | Copolymer-2 | 14.48 | 0.00 | 100.00 | 1.80% | 1.25% | 0.97 | 0.21 | 139.92 | 105.86 |
| Comparative 2 | Copolymer-2 | 14.95 | 4.67 | 100.00 | 1.93% | 3.03% | 2.45 | 0.54 | 146.20 | 114.34 |
| Comparative 3 | PolyTHF | 14.48 | 0.00 | 100.00 | 1.80% | 1.80% | 1.39 | 0.31 | 139.92 | 106.96 |
| Comparative 4 | PolyTHF | 18.61 | 0.00 | 100.00 | 1.44% | 1.44% | 1.16 | 0.26 | 144.97 | 110.10 |
| Comparative 5 | Copolymer-2 | 15.20 | 0.00 | 100.00 | 2.00% | 1.60% | 1.24 | 0.28 | 140.80 | 107.23 |

TABLE 3

| | | | | Modifier | | Mn | Mn | | | | | | |
|---|---|---|---|---|---|---|---|---|---|---|---|---|---|
| | | | | moiety | Mdo | (urethane)/ | (urea)/ | | | | | Elongation | Modulus/ |
| | P1/mm | P2/mm | P3/mm | content | (g/mol) | (g/mol) | (g/mol) | HS | H5 | b5 | RER % | % | MPa |
| Example 1 | 3.6 | 6.8 | 1.9 | 14.9% | 3336 | 7133 | 734 | 9.3% | 0.79 | 12.8 | 96 | 861 | 7.3 |
| Example 2 | 4.9 | 9.0 | 2.6 | 9.1% | 2931 | 6395 | 740 | 10.4% | 0.83 | 12.1 | 97 | 796 | 8.3 |
| Example 3 | 4.4 | 8.8 | 2.8 | 9.0% | 3075 | 6400 | 758 | 10.6% | 0.81 | 13.4 | 96 | 784 | 6.5 |
| Example 4 | 3.9 | 8.6 | 3.6 | 8.1% | 3010 | 5966 | 820 | 12.0% | 0.84 | 13.9 | 98 | 707 | 8.6 |
| Example 5 | 5.7 | 9.0 | 2.6 | 14.9% | 3020 | 7162 | 740 | 9.4% | 0.85 | 11.3 | 91 | 816 | 8.2 |
| Example 6 | 4.7 | 7.0 | 2.0 | 14.1% | 2631 | 6500 | 738 | 10.2% | 0.87 | 14.1 | 92 | 738 | 8.8 |
| Comparative1 | 3.4 | 5.6 | 1.7 | 8.3% | 4689 | 10687 | 749 | 6.5% | 0.76 | 16.6 | 87 | 952 | 6.2 |
| Comparative 2 | 4.9 | 8.7 | 6.7 | 8.3% | 3109 | 6893 | 1039 | 13.1% | 0.73 | 15.3 | 94 | 667 | 13.6 |
| Comparative 3 | 4.0 | 7.0 | 1.9 | 14.9% | 2984 | 6680 | 729 | 9.8% | 0.52 | 21.5 | 101 | 647 | 10.4 |
| Comparative 4 | 8.4 | 6.0 | 1.6 | 9.1% | 1802 | 7548 | 726 | 8.8% | 0.61 | 28.6 | 98 | 626 | 14.0 |
| Comparative 5 | — | — | — | — | — | — | — | — | — | — | — | — | — |

1. A polyurethane urea fiber or film, comprising:
a hard segment content of 8.0-13.0% by weight, wherein said hard segment content is defined by the equation:
$$\\ Hard segment content = \frac{Mn ( urea )}{Mn ( urethane ) + Mn ( urea )} * 100 \%$$
wherein said polyurethane urea fiber or film is prepared using a copolymer glycol.

2. The polyurethane urea fiber or film according to claim 1, wherein the hard segment content thereof is in the range of 8.0-12.5% by weight, urethane moieties have a number average molecular weight Mn (urethane) of 5000-9000 g/mol, and urea moieties have a number average molecular weight Mn (urea) of 500-900 g/mol.

3. The polyurethane urea fiber or film according to claim 1, wherein the copolymer glycol is prepared from at least one aromatic carboxylic acid and/or their anhydride and/or their ester with at least one polymeric glycol.

4. The polyurethane urea fiber or film according to claim 1, wherein a number average molecular weight (Mn) of the copolymer glycol is 500 to 5000 g/mol.

5. The polyurethane urea fiber or film according to claim 3, wherein the aromatic carboxylic acid, and/or their anhydride, and/or their ester moieties content in the copolymer glycol is 6.0-20.0% by weight.

6. The polyurethane urea fiber or film according to claim 3, wherein the aromatic carboxylic acid, and/or their anhydride, and/or their ester is at least one selected from the group consisting of isophthalic acid, dimethyl isophthalate, phthalic acid, terephthalic acid and their anhydrides.

7. The polyurethane urea fiber or film according to claim 3, wherein the polymeric glycol is at least one selected from the group consisting of polytetrahydrofuran glycol, polyesterol, polyetherol, polycaprolactone and mixtures thereof.

8. A process for producing the polyurethane urea fiber or film according to claim 1, comprising:
a) reacting copolymer glycol with at least one diisocyanate to obtain urethane prepolymer including isocyanate at both ends,
b) adding chain extender and optionally chain terminator to above urethane prepolymer under inert solvent to obtain polyurethane urea solution, and
c) dry spinning said polyurethane urea solution to obtain the polyurethane urea fiber.

9. The process according to claim 8, wherein the diisocyanate comprises 4,4′-methylene diphenyl diisocyanate.

10. The process according to claim 8, wherein the chain extender comprises aliphatic diamine having two hydrogen atoms reactive with isocyanate group.

11. The process according to claim 8, wherein the chain terminator is alkyl alcohol and/or dialkyl amine.

12. The process according to claim 8, wherein the amines other than chain extender and chain terminator are added together with the chain extender.

13. A method, comprising:
producing fabrics with the polyurethane urea fiber according to claim 1.

14. The polyurethane urea fiber or film according to claim 2, wherein hard segment content thereof is in the range of 8.5-12.5% by weight, the urethane moieties have a Mn (urethane) of 5500-8500 g/mol and the urea moieties have a Mn (uren) of 550-850 g/mol.

15. The polyurethane urea fiber or film according to claim 1, wherein a number average molecular weight (Mn) of the copolymer glycol is 1800 to 4000 g/mol.

16. The polyurethane urea fiber or film according to claim 1, wherein a number average molecular weight (Mn) of the copolymer glycol is 2000 to 3500 g/mol.

17. The polyurethane urea fiber or film according to claim 3, wherein the aromatic carboxylic acid, and/or their anhydride, and/or their ester is at least one selected from the group consisting of isophthalic acid, dimethyl isophthalate, and mixtures thereof.

18. The polyurethane urea fiber or film according to claim 3, wherein the aromatic carboxylic acid, and/or their anhydride, and/or their ester is isophthalic acid.

19. The polyurethane urea fiber or film according to claim 3, wherein the polymeric glycol comprises polytetrahydrofuran glycol.
